(19) United States
(12) Patent Application Publication
(10) Pub. No.: US 2003/0131003 A1
(43) Pub. Date: Jul. 10, 2003

(54) Network database system for providing database output in a plurality of strings of sequential data segments through a user interface with dimensions limiting the data capacity of each segment

(75) Inventor: Margaret Gardner MacPhail, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/042,107

(22) Filed: Jan. 8, 2002

(51) Int. Cl. G06F 7/00

(52) U.S. Cl. 707/10

(57) ABSTRACT

Providing a user with database output through a user interface having predefined dimensions limiting the capacity of each iterative segment of output comprising a database for storing a plurality of different types of output data in combination with an implementation for providing data segments for each of the different types of stored data, with each segment having a capacity limited by said predefined dimensions of said user interface. A plurality of strings of the segments, each string including a sequence of segments of one different type of stored data is presented to the user at the user interface, and the user is enabled to select one of said strings of segments to be thereby sequentially output through said user interface.

### TECHNICAL FIELD

The present invention relates to outputting of data from networked database sources such as World Wide Web (Web) databases through receiving terminals or stations on the network having a wide variety of user interfaces.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

With this broad expansion of facilities and network traffic, there has arisen the need to improve the organization and distribution to the wide variety of new users, and the increased scope of their varied interests. This distribution problem has been further compounded by the development of computer controlled interfaces through which users receive data from databases on the Web or Internet (the terms are used synonymously herein) or like public and private networks. The size of computer controlled display interfaces in terminals through which users may access data from network databases has become extensively varied, and the attendant data throughput via such interfaces has similarly varied. In addition to the wide size variety of simple desktop network display stations or terminals, Internet presentations are now being made on display interfaces in the order of eight by twelve feet for remote seminars, entertainment and sporting events. On the other end, the small display, Personal Digital Assistant (PDA) display terminals, such as the 3Com PalmPilot™ and the International Business Machines Corporation's (IBM) WorkPad™ have been building a user base over the past few years. Current estimates are that the number of these devices in present usage, including cellular display telephones, is in the order of hundreds of millions. Initially, the palm-type computers accessed the Web through the Web browser programs of the desktop computer with which the palm-type device was synchronized, e.g. HotSynced, where the device is synchronized with a desktop personal computer that functions as a receiving station on the Web so that the communication may be through the synchronized personal computer. In recent years, there has been developed a networking protocol: TCP/IP, which permits direct connection of personal palm devices to the Web through PDA modems, which are described in greater detail at pp. 148-149 of the text Palm III & PalmPilot, Jeff Carlson, Peachpit Press, 1998.

In view of this wide variation in user interfaces receiving data from databases on networks such as the Web, there is a need to provide network database output that attempts to be optimized to the particular user interface though which the output data is being received.

### SUMMARY OF THE PRESENT INVENTION

The present invention is a network database system, method and program for providing a user with database output through a user interface having predefined dimensions limiting the capacity of each iterative segment of output comprising database means for storing a plurality of different types of output data in combination with means for providing data segments for each of the different types of stored data, with each segment having a capacity limited by said predefined dimensions of said user interface. There are means for providing a plurality of strings of said segments, each string including a sequence of segments of one different type of stored data, and means enabling a user to select one of said strings of segments to be thereby sequentially output through said user interface. The invention is advantageously used for display interfaces on the Web. The strings of segments may each include data of a type different from the other data strings. Such data may be text, image or moving image, e.g. video segments. Audio strings may be similarly provided.

It should be noted that the capacity of each segment has been described as limited by the predefined dimensions of said interface. This is not intended to mean that the data in each segment has to be organized so that the data will be displayed in a series of screen frames, with the data in each frame not exceeding the dimensions of the screen. The data in such screen frames may exceed the dimensions of the display screen so appropriate scrolling to display all of the data in the frame on the screen. However, the overall data in a segment would be limited by the predefined display screen dimensions, e.g. segments of data intended to be displayed on a palm-type display device would have a segment capacity different from segments of data intended to be displayed on the larger desktop screen. Similarly, segments in a data string intended to be displayed on a lecture hall display would have a segment capacity substantially greater than segments of data intended to be displayed on the desktop screen.

In an application of the present invention, the owner or host of the database source on the Web may provide the output data, e.g. Web pages in a basic form optimized for desktop computer display station interfaces, and further provides for the Web pages in alternate default forms of segmented data strings; for example, for extra large and for extra small display user interfaces, as will be hereinafter described in greater detail. Since the Web pages are Hyper Text Markup Language (HTML) documents, the user or the service provider for the user may be enabled to select one of these two alternate default segmented string forms by the insertion of appropriate HTML tags in the Web pages by the database source hosts.

The sequence of the segments of the strings of output data provided by the resource database host may be modified by the Web service provider or by the user at the receiving display terminal. Also, some modification of the data content within the segments may be enabled at these two distribution levels.

The user does not have to view and/or work with the segment in a string in the same sequence that the segment is ordered in the string. For example, the user may “pull”, i.e. “fast-forward”, a sequence of segments in a string through the display interface until a selected segment is reached, and then view or work with only the selected segment. The user may do standard interactive work on the selected segment, e.g. change font size or reduce or enlarge the image.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network such as a Web portion on which the present invention may be implemented;

FIG. 2 is a block diagram of a data processing system including a central processing unit and network connections via a communications adapter that is capable of functioning both as a receiving display terminal interface for receiving data string segments, and as the server used to access databases of the Web or like networks;

FIG. 3 is an illustrative interactive display menu enabling a user at a receiving display terminal to select one of a plurality of data strings provided to him;

FIG. 4 is an illustrative interactive display menu enabling a user at a receiving display terminal who has selected one of the data strings of FIG. 3 to modify the sequence of segments in the data string;

FIG. 5 is the illustrative interactive display menu of FIG. 4 after the user has modified the sequence of the segments in the data string;

FIG. 6 is an illustrative interactive display menu like that of FIG. 4 enabling a user at a receiving display terminal who has selected another of the data strings of FIG. 3 to modify the sequence of segments in the data string;

FIG. 7 is an illustrative flowchart describing the setting up of the elements of the present invention for storing a plurality of different types of output data in combination with means for providing data segments for each of the different types of stored data, with each segment having a capacity limited by said predefined dimensions of said user interface; and

FIG. 8 is a flowchart of an illustrative run of the program set up in FIG. 7.

### DETAILED DESCRIPTION OF THE PREFERRED EMBODIMENT

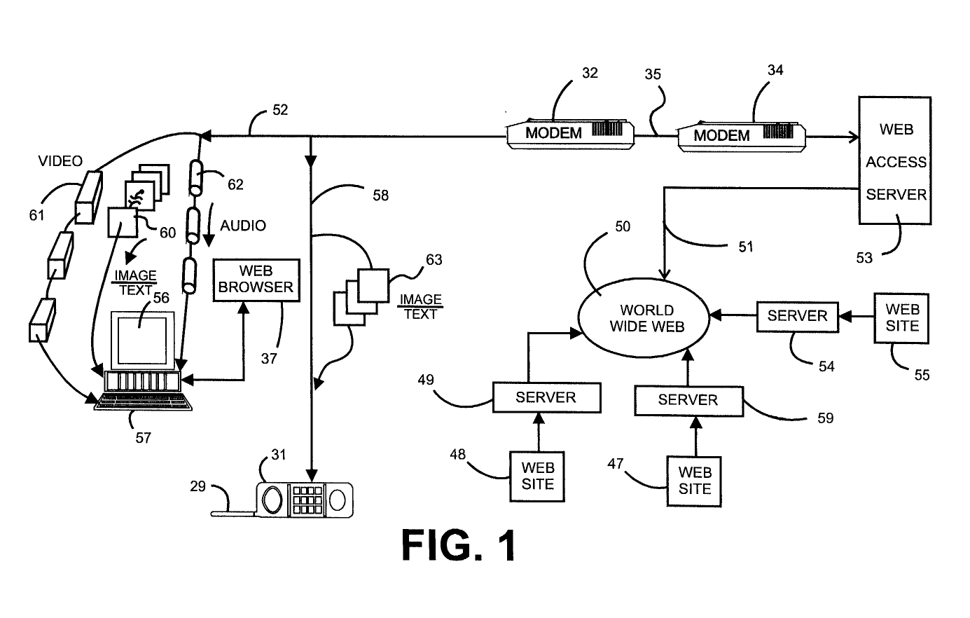

Referring to FIG. 1, there is shown a very generalized diagram of a Web portion on which the present invention may be implemented. In the examples which follow, we will use the Web as the network. Actually, the present invention may be implemented on any appropriate network.

A local computer controlled display terminal 57 having a user interactive display interface 56 and controlled by a conventional Web browser program 37 is typically connected to the Web 50 via standard Web wired modem connections. Reference may be made to the text, Mastering the Internet, G. H. Cady et al., published by Sybex Inc., Alameda, Calif., 1996, particularly pp. 136-147, for typical connections between local display stations to the Web 50 via access server 53 through connection 51. The embodiment of FIG. 1 has a host-dial connection. Such host-dial connections have been in use for over 30 years through network access servers 53 that are linked 51 to the Web 50. The servers 53 may be maintained by a service provider to the user of Web terminal 57. The host's server 53 is accessed by the Web terminal 57 through a normal dial-up telephone linkage 52 via modem 32, telephone line 35 and modem 34.

The user may also access the Web through an alternate display, the smaller palm-type display device 31. Such palm-type devices are configured to access the Web both directly or through a synchronized related desktop computer. However, before proceeding further with this description, we will, at this point, provide some background with respect to the PDAs or personal palm-type devices that may be used to provide smaller display interfaces in accordance with the present invention. The most common PDAs included in the present generic definition: personal palm-type devices include Microsoft's WinCE line; the PalmPilot line produced by 3Com Corp.; and IBM's WorkPad. These devices are comprehensively described in the previously mentioned text, Palm III & PalmPilot. Palm-type computer 31, as shown in FIG. 1, which may be connected directly into the Web 50, as will be later described, contains a data processor, operating system and application programs in a device Random Access Memory (RAM). Also included is a programmable Read Only Memory (ROM) that may be an EPROM or flash ROM, which are described in the above-referenced text, Palm III & PalmPilot, at page 38.

The palm-type computer 31, as shown, may access the Web through the Web browser program 37 of the desktop computer 57 if the palm-type device was synchronized, e.g. HotSynced, with desktop personal computer 57 that functions as a receiving station on the Web so that the communication may be through the synchronized personal computer. In recent years, personal palm-type devices have also developed a networking protocol: TCP/IP that permits direct connection of palm-type computer 31 to the Web through PDA modems, which are described in greater detail at pp. 148-149 of the Palm III & PalmPilot text. These individual mobile palm-type devices 31 may be directly connected to their respective service provider servers 53. The mobile palm-type display device 31 transmits/receives via antenna 29 to/from a wireless terminal receiver connected via a wireless Local Area Network (LAN) to the service provider server 53. Data is displayed on the display screen of the palm-type device 31. It should be noted that the terms “personal palm-type device” or “computer” are used to generally cover all varieties of palm-type devices. These include cellular telephones and related wireless devices, smartphones and Internet screen phones.

Since a major aspect of the present invention is directed to documents, such as Web pages, transmitted over networks, an understanding of networks and their operating principles would be helpful. We will not go into great detail in describing the networks to which the present invention is applicable. Reference has also been made to the applicability of the present invention to a global network such as the Internet or Web. For details on Internet nodes, objects and links, reference is again made to the text, Mastering the Internet.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such MPEG, JPEG or GIF files, which are described in the text, Internet: The Complete Reference, Millennium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

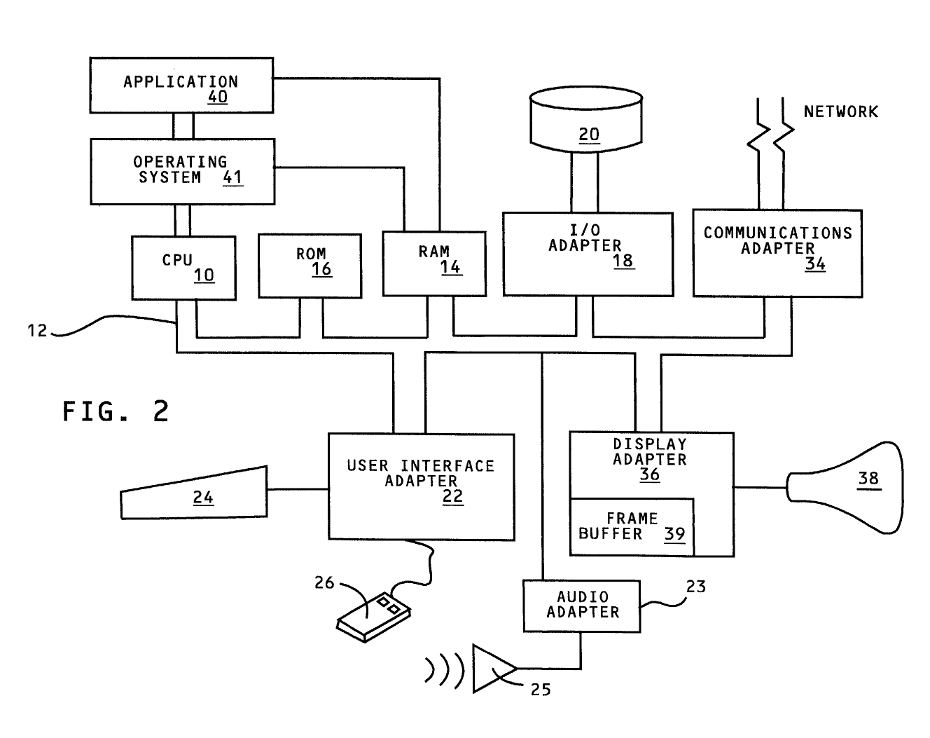

In searching or browsing on the Web for information to be presented to the user at terminals 31 or 57, the Web servers 53, which may have the computer structure to be described with respect to FIG. 2, may be maintained by an Internet Service Provider (ISP) to the client's display terminal 57. The Web server 53 is accessed by the client terminal 57 through a normal dial-up telephone linkage 52 via modem 32, telephone line 35 and modem 34. The HTML file representative of the Web page 56 is conventionally downloaded to display terminal 57 through Web access server 53 via the telephone line linkages from server 53, which may have accessed the file from the Web 50 via linkage 51. The Web browser program 37 operates within the display terminal 57 to control the communication with the Web access server 53 to thereby download and display the accessed Web pages 56 on terminal 57. The Web access server 53 uses a conventional Web search engine to access via the Web 50 the desired sequence of Web documents from appropriate Web site resources, such as databases 47, 48 and 55, respectively connected to the Web 50 via servers 59, 49 and 54.

The data thus accessed from these Web site databases is to be organized so as to be presented at the user's receiving terminal, i.e. either terminal 57 or 31, as strings of segments of different data types wherein each segment in the respective string has a data capacity limited by the predefined dimensions of the output interface of the terminal. For this purpose of illustration, we have shown two illustrative terminals with interfaces of two different dimensions, large and small. The same principles of operation would be applicable if we also had a very large capacity display interface, as on an 8′×12′ lecture hall screen in addition to the interfaces shown. Three illustrative strings: text/image 60, video 61 and audio 62, of data segments are shown. Also, an illustrative data string 63 of text/image segments defined by the dimensions of the palm-type device 31 is also shown. The respective strings have segments, the contents of which are sized based upon the dimensions of their respective interfaces so as to maximize interface throughput.

In determining the size of the various segments in the segment strings, the host or designer of the Web documents provided from Web site databases, such as Web site 47, 48 or 55, the host of the Web page may, by using HTML standard tags in the documents, provide for, let us say, three default string segment sizes optimized for three interface formats, e.g. desktop display, palm-type display or lecture size display interfaces. Then, the service provider's Web access server unit, which may have stored special information regarding the user/client needs, may modify or reorganize the sizes of the segments in each string based upon such user preferences and needs. Finally, as will be hereinafter described in greater detail, the user at the receiving display terminal is enabled to make selective modifications.

Referring now to FIG. 2, a typical data processing terminal is shown that may function as the computer controlled network display terminals or Web display stations used for receiving Web documents. The computer set up shown may also function as the Web access servers 53 of the service providers in FIG. 1. A central processing unit (CPU) 10, such as one of the PC microprocessors or workstations, e.g. eServer pSeries available from International Business Machines Corporation (IBM), or Dell PC microprocessors, is provided and interconnected to various other components by system bus 12. An operating system 41 runs on CPU 10, provides control and is used to coordinate the function of the various components of FIG. 2. Operating system 41 may be one of the commercially available operating systems such as IBM's AIX 6000™ operating system or Microsoft's WindowsMe™ or Windows 2000™, as well as UNIX and other IBM AIX operating systems. Application programs 40, controlled by the system, are moved into and out of the main memory RAM 14. These programs include the various routines and programs of the present invention to be described subsequently in greater detail for organizing the strings of data segments both in the receiving user terminal and in the service provider's Web access server. A ROM 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for sizing the strings of segments in accordance with the present invention.

Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26, and receiving output information from the system via display 38, through speaker 25 via audio output adapter 23.

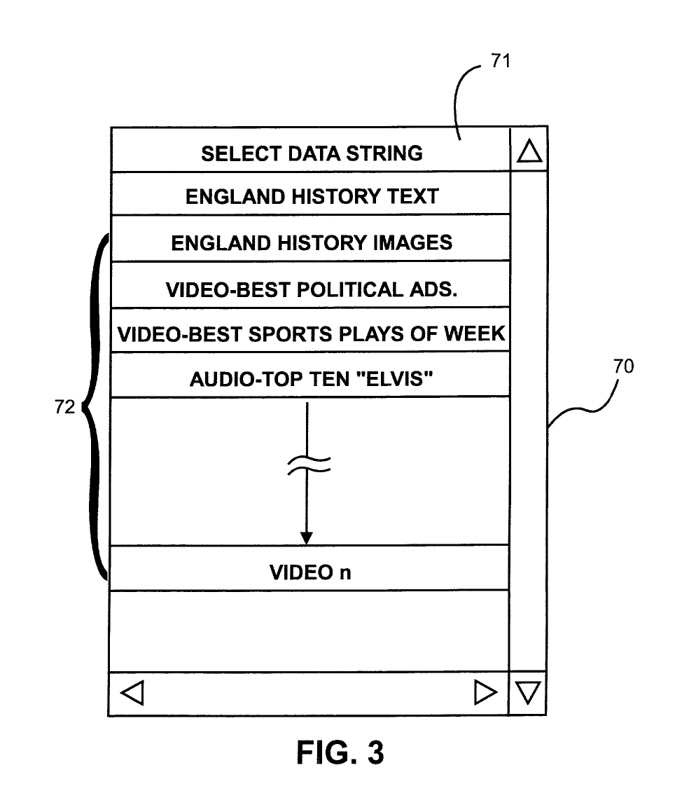

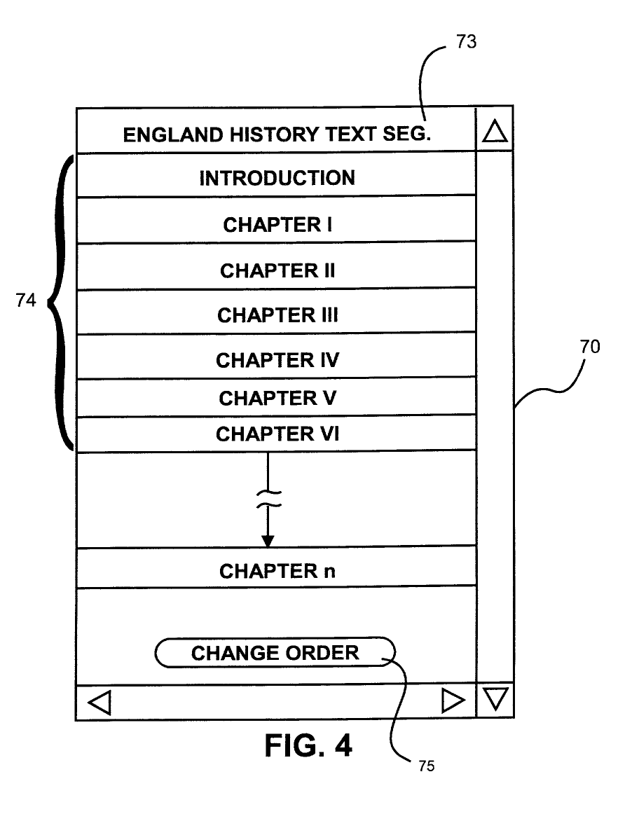

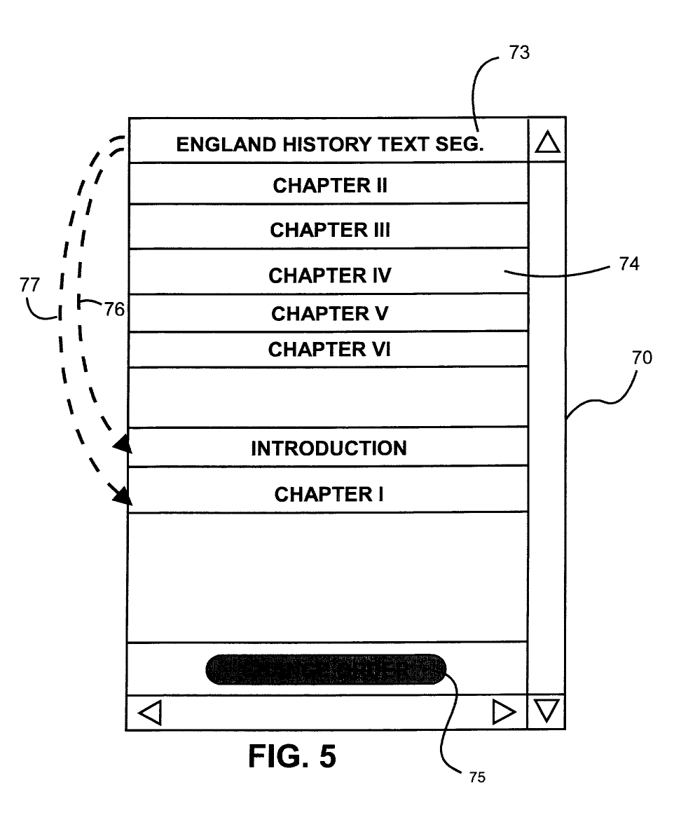

Now, with respect to FIGS. 3 through 6, we will provide some examples of the choices that the user at a receiving display terminal is enabled to make with respect to the plurality of strings of sequential data segments being offered to him. In FIG. 3, the user is offered a selection of a plurality of strings of data segments of different data. In dialog box 70, the user is requested to select 71 a string of segmented data from a menu 72. As shown in FIG. 4, the user has selected a string of text segments that are chapters in a text, “England History” 73, and is presented with a menu of segments 74. As shown in FIG. 5, the user may rearrange the data segments 74 by moving two of the segments 76 and 77. The dialog box 70 enables the user to, thus, change the order of the segments by clicking on the button 75 marked “Change Order”.

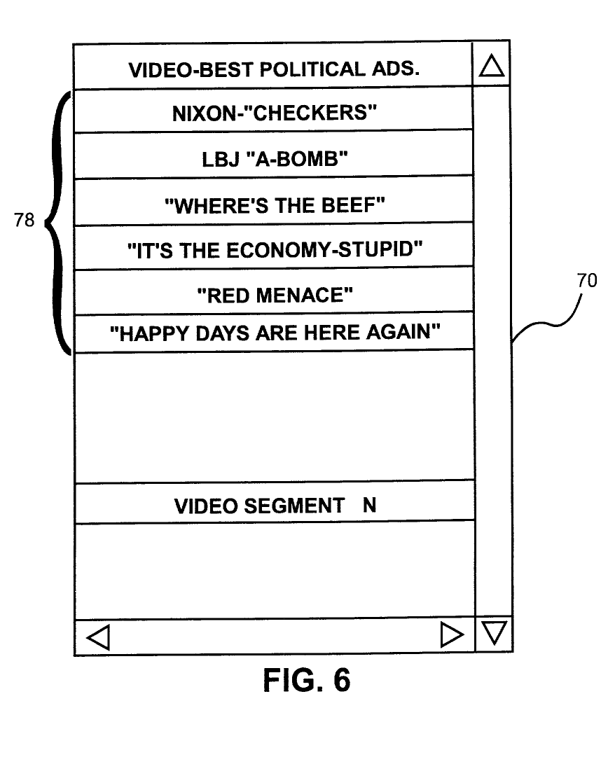

In FIG. 6, there is shown a variation where the user in FIG. 3 has selected another string of segments, “The Video—Best Political Advertisements”, and been offered a menu 78 of segment choices.

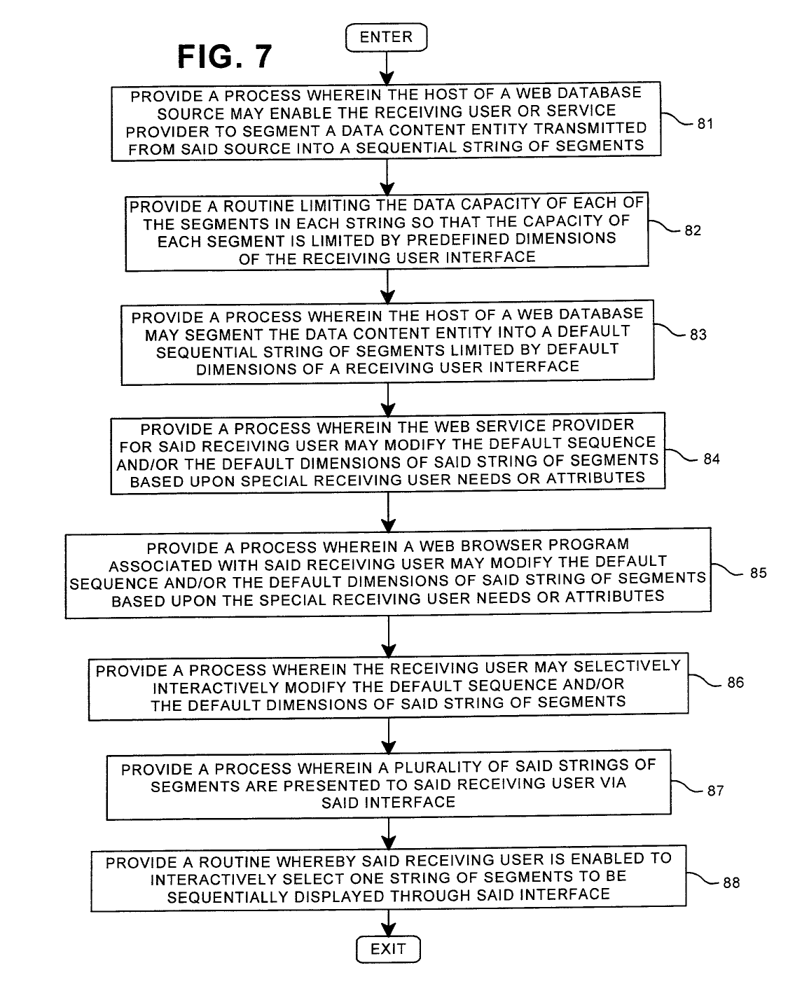

FIG. 7 is a flowchart showing the development of a process according to the present invention for providing data content from one or more database sites on the Web to a user at a receiving display station in the form of a plurality of segmented data strings from which the user may select a string of segments for sequential display.

A process is provided by which a host of a database Web site may enable the receiving user or the Service Provider for such user to segment or modify a data content entity transmitted from the Web source in the form of a string of data segments, step 81. Of course, the host or creator of the source database output may also be enabled to segment the data content entity into the string of segments. The segments in the string should provide a logical segmented presentation of the data content entity. A routine is provided to limit the data capacity of each of the segments in each of the strings to the predefined dimensions of the receiving user interface, step 82. A process is provided wherein the host of a Web site database may segment the data content entity into a default sequential string of segments limited by the default dimensions of the receiving user interface, step 83. Then, a process is provided wherein the Service Provider for the receiving user may modify the default sequence and/or the default dimensions of the string of segments based upon special receiving user needs and attributes, step 84. A process is provided wherein a Web browser program associated with a receiving user display station is able to modify the default sequence and/or the default dimensions of the string of segments based upon special receiving user needs or attributes, step 85. A process is provided so that the receiving user may selectively interactively modify the default sequence and/or the default dimensions of the string of segments, step 86. A process is also provided by which a plurality of the segment strings are presented to the receiving user via the user interface, step 87. Finally, a process is provided whereby the receiving user is enabled to interactively select one of the string of segments to be sequentially displayed through the interface, step 88.

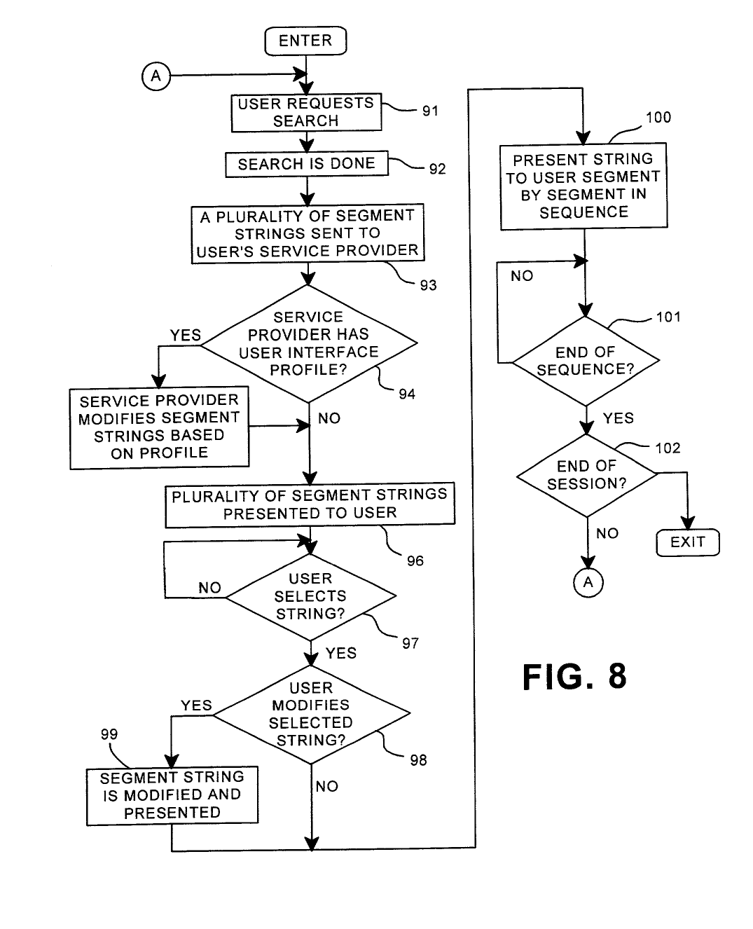

The running of the process set up in FIG. 7 will now be described with respect to the flowchart of FIG. 8. This is a simplified illustration as to how the structure of the plurality of segmented data strings of different data types may be organized, augmented and modified at each of the distribution levels in the transmission of the segmented data strings from a database source on the Web to the receiving display terminal.

The user at the receiving display station requests a search that provides data from source databases on the Web, step 91. Upon completion, step 92, of the search, let us assume that the search results are provided as strings of segments of data, each segment is initially defined by default limitations provided by the hosts of the source databases. The default segment limitations may be initially determined by the source host based upon the anticipated type of display interface at the receiving station, step 93. A determination is then made as to whether the Service Provider at the Web server has a user interface profile for the user or client of the requesting display station, step 94. If Yes, then the segments in the data string are modified at this Web server level base upon this profile, step 95, and sent on to the receiving display station. Then, or if the decision from step 94 is No, the results of this process are presented to the user on the receiving display along with like results from other elements of the search from other databases as a plurality of segment strings of different types of data, step 96. A determination is then made, step 97, as to whether the user has selected a string of segments. If No, the routine is returned to step 97 where such a selection is awaited. If Yes, then a further determination is made as to whether the user has elected to modify the selected string, step 98. If Yes, the presented string is modified according to the user specifications, step 99. Then, or if the decision of step 98 is No modification of the segment string, the selected string is presented to the user sequentially segment by segment, step 100. At this point a determination is made as to whether we are at the end of the selected string of segments, step 101. If Yes, then a further determination may conveniently be made as to whether we are at the end of the search session, step 102. If Yes, then the session is exited. If No, then the searching is continued by returning to any appropriate step in the search and distribution process. In this example, the process was returned to step 91 via branch “A” for further searching, or the process could have been returned to step 97 for the user selection of another string of segments.

One of the preferred implementations of the present invention is in application program 40, i.e. a browser program made up of programming steps or instructions resident in RAM 14, FIG. 2, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled database system for providing a user with database output through a user interface having predefined dimensions limiting the capacity of each iterative segment of output comprising:
database means for storing a plurality of different types of output data;
means for providing data segments for each of the different types of stored data, each segment having a capacity limited by said predefined dimensions of said user interface;
means for providing a plurality of strings of said segments, each string including a sequence of segments of one different type of stored data;
means enabling a user to select one of said strings of segments to be output; and
means for outputting said selected string of segments at said user interface.

2. The computer controlled database system of claim 1 wherein:
said user interface is a computer controlled display interface; and
said database means for storing said output data is connected to said user interface through a network.

3. The database system of claim 2 wherein said network is the World Wide Web.

4. The database system of claim 3 wherein at least one of said strings includes a sequence of segments of image type of data.

5. The database system of claim 3 wherein at least one of said strings includes a sequence of segments of text type of data.

6. The database system of claim 3 wherein at least one of said strings includes a sequence of segments of video type of data.

7. The database system of claim 2 wherein at least one of said strings includes a sequence of segments of audio type of data.

8. The database system of claim 3 wherein said computer controlled display interface is on a receiving display station on said World Wide Web.

9. The database system of claim 8 wherein said means for providing said strings of data segments are associated with said database means connected by the World Wide Web to said receiving display station.

10. The database system of claim 9 wherein:
said World Wide Web further includes a service provider for organizing and providing data from database sources on said World Wide Web to said receiving display station; and
said service provider includes said means for providing said plurality of strings of said segments to said receiving display station.

11. The database system of claim 10 wherein said receiving display station further includes means for selecting and displaying one of said plurality of strings of said segments provided to said receiving display station.

12. The database system of claim 11 wherein said receiving display station further includes means for changing the order of segments to be displayed in a selected one of said plurality of strings of segments.

13. In a computer controlled database system a method for providing a user with database output through a user interface having predefined dimensions limiting the capacity of each iterative segment of output comprising:
storing, in databases, a plurality of different types of output data;
providing data segments for each of the different types of stored data, each segment having a capacity limited by said predefined dimensions of said user interface;
providing a plurality of strings of said segments, each string including a sequence of segments of one different type of stored data;
enabling a user to select one of said strings of segments to be output; and
outputting said selected string of segments at said user interface.

14. The method of claim 13 wherein:
said user interface is a computer controlled display interface; and
said database means for storing said output data is connected to said user interface through a network.

15. The method of claim 14 wherein said network is the World Wide Web.

16. The method of claim 15 wherein at least one of said strings includes a sequence of segments of image type of data.

17. The method of claim 15 wherein at least one of said strings includes a sequence of segments of text type of data.

18. The method of claim 15 wherein at least one of said strings includes a sequence of segments of video type of data.

19. The method of claim 14 wherein at least one of said strings includes a sequence of segments of audio type of data.

20. The method of claim 15 wherein said computer controlled display interface is on a receiving display station on said World Wide Web.

21. The method of claim 20 wherein steps of providing said strings of data segments is carried out at said databases of stored data connected by the World Wide Web to said receiving display station.

22. The method of claim 21 wherein:
said World Wide Web further includes a service provider for carrying out steps of organizing and providing data from database sources on said World Wide Web to said receiving display station; and
said service provider further provides said plurality of strings of said segments to said receiving display station.

23. The method of claim 14 further including steps of selecting and displaying one of said plurality of strings of said segments provided to said receiving display station.

24. The method of claim 23 further including the step of changing the order of segments to be displayed in a selected one of said plurality of strings of segments at a receiving display station.

25. A computer program having program code included on a computer readable medium for providing a user with a database system output through a user interface having predefined dimensions limiting the capacity of each iterative segment of output comprising:
database means for storing a plurality of different types of output data;
means for providing data segments for each of the different types of stored data, each segment having a capacity limited by said predefined dimensions of said user interface;
means for providing a plurality of strings of said segments, each string including a sequence of segments of one different type of stored data;
means enabling a user to select one of said strings of segments to be output; and
means for outputting said selected string of segments at said user interface.

26. The computer program of claim 25 wherein:
said user interface is a computer controlled display interface; and
said database means for storing said output data is connected to said user interface through a network.

27. The computer program of claim 26 wherein said network is the World Wide Web.

28. The computer program of claim 27 wherein at least one of said strings includes a sequence of segments of image type of data.

29. The computer program of claim 27 wherein at least one of said strings includes a sequence of segments of text type of data.

30. The computer program of claim 27 wherein at least one of said strings includes a sequence of segments of video type of data.

31. The computer program of claim 26 wherein at least one of said strings includes a sequence of segments of audio type of data.

32. The computer program of claim 27 wherein said computer controlled display interface is on a receiving display station on said World Wide Web.

33. The computer program of claim 32 wherein said means for providing said strings of data segments are associated with said database means connected by the World Wide Web to said receiving display station.

34. The computer program of claim 33 wherein:
said World Wide Web further includes a service provider for organizing and providing data from database sources on said World Wide Web to said receiving display station; and
said service provider includes said means for providing said plurality of strings of said segments to said receiving display station.

35. The computer program of claim 34 wherein said receiving display station further includes means for selecting and displaying one of said plurality of strings of said segments provided to said receiving display station.

36. The computer program of claim 35 wherein said receiving display station further includes means for changing the order of segments to be displayed in a selected one of said plurality of strings of segments.
